(19) United States
(12) Patent Application Publication
(10) Pub. No.: US 2025/0259052 A1
(43) Pub. Date: Aug. 14, 2025

(54) GRAPH NEURAL NETWORK WITH POINTED DIRECTIONAL MESSAGE PASSING

(71) Applicant: PAYPAL, INC., San Jose, CA (US)

(72) Inventor: Ofek Levy, Tel Aviv (IL)

(21) Appl. No.: 18/440,453

(22) Filed: Feb. 13, 2024

(51) Int. Cl. G06N 3/08

(52) U.S. Cl. CPC G06N 3/08

(57) ABSTRACT

A graph network of a service provider is accessed. The graph network includes a plurality of nodes interconnected by a plurality of edges. A plurality of sub-graphs is generated. Each of the sub-graphs corresponds to a different portion of the graph network. Each of the sub-graphs includes a different subset of the plurality of nodes. A directional flow for information exchanges is defined between the nodes of each of the sub-graphs. A graph neural network (GNN) model is trained based on the defined directional flow. The trained GNN model is utilized to generate one or more predictions.

### BACKGROUND

### Field of the Invention

The present application generally relates to machine learning. More particularly, the present application involves improving machine learning efficiency and accuracy by reducing redundancies associated with network hops.

### Related Art

Over the past several decades, rapid advances in integrated circuit fabrication and wired/wireless telecommunications technologies have brought about the arrival of the information age, where electronic activities and/or online transactions are becoming increasingly more common. Machine learning has been used to train models that can be used to make predictions, such as potential fraud or risks associated with a decision. However, the training of many machine learning models may involve passing electronic messages back and forth among various nodes, which may be redundant, unnecessary, or misleading, resulting in a reduction of the training of the machine learning model and an accuracy of the predictions made by the machine learning model. Therefore, although existing machine learning processes are generally adequate for their intended purposes, they have not been entirely satisfactory in every aspect. What is needed is an improved machine learning process that can reduce the redundant message passing among the nodes, which in turn can improve the efficiency of the model training and the accuracy of the predictions made by the trained model.

### BRIEF DESCRIPTION OF THE FIGURES

FIG. 1 is a block diagram of a networked system according to various aspects of the present disclosure.

FIG. 2 illustrates an example graph network containing a plurality of interconnected nodes according to various aspects of the present disclosure.

FIG. 3 illustrates a simplified block diagram corresponding to a machine learning process according to embodiments of the present disclosure.

FIG. 4 illustrates a directional information flow as a part of a graph neural network (GNN) model training according to embodiments of the present disclosure.

FIG. 5 illustrates a computer system according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is a flowchart illustrating a method of generating a decision based on de-biased machine learning models according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to an improved machine learning process, in which a directional flow is defined for information exchanges among the nodes of a graph neural network (GNN) machine learning model, so as to reduce undesirable smoothing between the nodes. In more detail, a GNN may include a plurality of nodes that are interconnected, where each of the nodes has feature information embedded therein. During the training of the GNN, each node and its neighboring nodes pass information or data back and forth therebetween. This is referred to as message passing. However, as a depth of the GNN increases, more information is passed back and forth among the nodes, including redundant information. For example, a node A may have already passed its feature information to node B in a previous model training cycle, and now node A is receiving the same feature information from node B in a current model training cycle, even though feature A already has this information. Not only is this redundant information exchange a waste of electronic resources, it also may make the nodes (e.g., nodes A and B in this example) more alike, especially as more model training cycles are executed. This may be referred to as a smoothing problem, and it may degrade the accuracy of the predictions made by the trained GNN model.

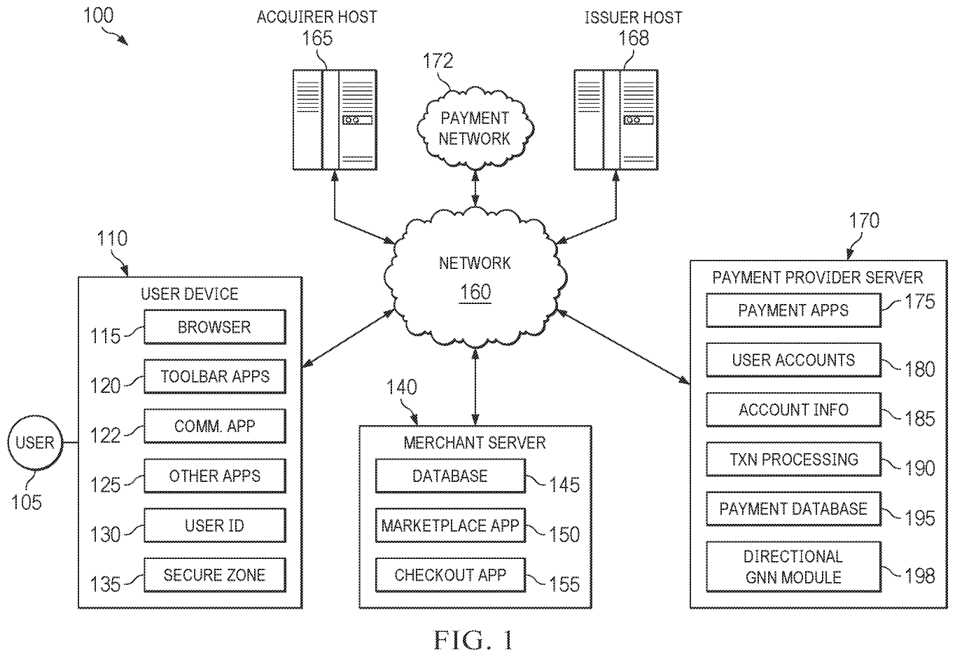

The present disclosure overcomes the above problem by making the information flow directional, so as to avoid the redundant information exchanges (and the smoothing problem resulting from the redundant information exchanges) in conventional GNNs. In more detail, the present disclosure executes an algorithm to ensure that for every node in a GNN, information is propagated in a direction toward a point node. In other words, a directional flow of information is defined for every node of the GNN, which prevents information from flowing redundantly back and forth among neighboring nodes. As a result, the smoothing problem in conventional GNNs is substantially alleviated, and the GNN of the present disclosure can be trained faster/more efficiently, and/or make more accurate predictions. The various aspects of the present disclosure are discussed in more detail with reference to FIGS. 1-8.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a digital wallet provider (e.g., a payment service provider), such as PayPal™ Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

The merchant server 140 may also host a website for an online marketplace, where sellers and buyers may engage in purchasing transactions with each other. The descriptions of the items or products offered for sale by the sellers may be stored in the database 145. The merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, third party financial service providers, such as associated with payment provider server 170, credit cards, debit cards, checks, money orders, or the like.

Payment provider server 170 may be maintained, for example, by an online digital wallet provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a directional GNN module 198 may also be implemented on the payment provider server 170. The directional GNN module 198 defines a directional flow for an information exchange (e.g., a passing of an electronic message or data) among a plurality of interconnected nodes in a GNN. In some embodiments, the directional GNN module 198 may access a large graph network maintained by an entity (e.g., the payment provider associated with the payment provider server 170 or the merchant associated with the merchant server 140). The large graph network comprises a plurality of nodes interconnected by a plurality of edges. In some embodiments, the nodes represent different entities (e.g., users of the payment provider, such as the user 105), and the edges each represent a relationship, an interaction, or a transaction between the two entities interconnected by the edges.

Based on the large graph network, the directional GNN module 198 generates a plurality of batches of sub-graphs that each correspond to a different portion of the graph network, where each sub-graph contains a different subset of the nodes. This is done because the sub-graphs are at the size that is more suitable for data processing by a graphics processing unit (GPU) as a part of the machine learning training. Each sub-graph includes a respective point node that represents an entity of interest. In some embodiments, the entity of interest may include a user that may be associated with a potentially fraudulent activity, or it may include a merchant whose business metric (e.g., a total payment volume) needs to be determined. The rest of the nodes in the sub-graph are connected to the point node within N-hops, where N is a predefined number (e.g., N=2, or N=3). The directional GNN module 198 defines and/or implements a directional flow for information exchanges among the subsets of the nodes of each of the sub-graphs, such that no or very little (less than a threshold number that may vary based on the system, training objectives, etc.) unintended redundant information is exchanged between neighboring nodes. In some embodiments, the directional flow is defined at least in part based on a distance between the point node and each of the nodes in a sub-graph within which the point node is located.

The sub-graphs with the defined directional information flow are used to train the GNN models. Due to the elimination (or at least substantial reduction) in the passing of redundant information between the interconnected nodes in the sub-graphs, less computer resources (e.g., computer processing power, electronic memory usage, network bandwidth) are used to perform the machine learning model training. In addition, the machine learning models can be trained faster and more efficiently. For at least these reasons, the system 100 herein offers an improvement in computer technology. Furthermore, the elimination or reduction in the redundant messages alleviates the smoothing problem plaguing conventional GNN models. As a result, the nodes in the GNN models herein are more distinct from one another, and the models trained using these more distinct nodes can be used to make more accurate predictions, such as predictions with respect to a transaction or offer, such as likelihood of fraud, total payment volume, or credit/loan approval. Since inaccurate predictions would have otherwise required additional computing resources to remedy or address the sub-optimal outcomes resulting from the inaccurate output of the machine learning models, the enhanced accuracy offered by system 100 herein further amounts to an improvement in computer technology.

It is noted that although the directional GNN module 198 is illustrated as being separate from the transaction processing application 190 in the embodiment shown in FIG. 1, the transaction processing application 190 may implement some, or all, of the functionalities of the directional GNN module 198 in other embodiments. In other words, the directional GNN module 198 may be integrated within the transaction processing application 190 in some embodiments. In addition, it is understood that the directional GNN module 198 (or another similar program) may be implemented on the merchant server 140, on a server of any other entity operating a social interaction platform, or even on a portable electronic device similar to the user device 110 (but may belong to an entity operating the payment provider server 170) as well.

It is also understood that the directional GNN module 198 may include one or more sub-modules that are configured to perform specific tasks. For example, in some embodiments, the directional GNN module 198 may include a sub-module configured to generate batches of sub-graphs based on a large graph network, another sub-module configured to define the directional flow of the information exchanges among the nodes of the sub-graphs, a further sub-module configured to train a machine learning model based on the sub-graphs (with the defined directional flow), and yet another sub-module configured to make predictions based on the trained machine learning models, etc. For reasons of simplicity, the different sub-modules (if they are implemented as such) are not specifically illustrated in FIG. 1.

Still referring to FIG. 1, the payment network 172 may be operated by payment card service providers or card associations, such as DISCOVER™, VISA™, MASTERCARD™ AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank or other financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

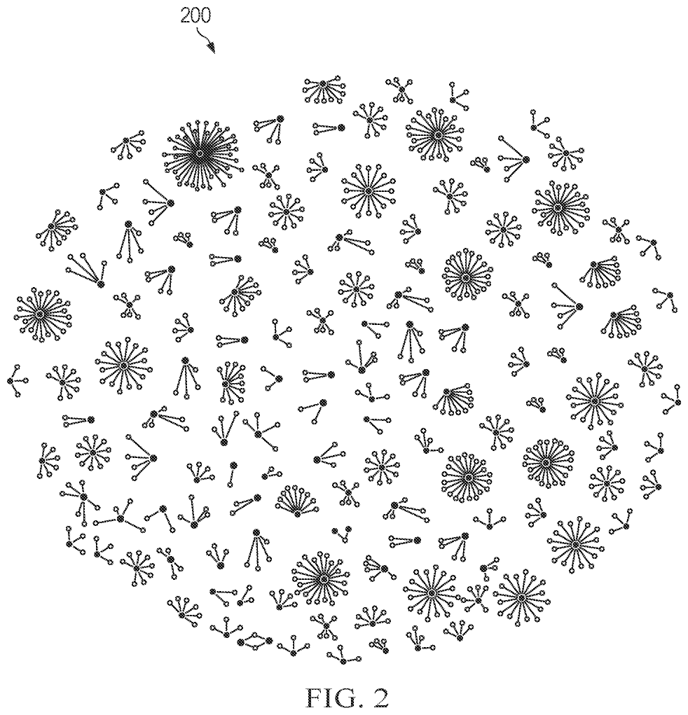

FIG. 2 illustrates a graph network 200 that visually represents a plurality of transactions conducted using a service provider platform (e.g., a third-party payment provider that maintains the payment provider server 170 of FIG. 1) and the entities involved in the transactions. In some embodiments, the graph network 200 includes a plurality of nodes (also referred to as vertices) that each represents an entity (e.g., a user or a merchant) involved in a respective transaction. The graph network 200 may also include a plurality of edges that interconnect the nodes, where the edges each represent a respective transaction. The nodes may include features that correspond to information regarding the entities themselves, such as username, password, bank account number, etc. Meanwhile, the edges may correspond to information regarding the actual transactions between the entities represented by the nodes, such as the names of the buyer and/or seller, the transaction amount, the transaction time, and/or the items involved in the transaction, etc. The graph network 200 (or a similar graph network) may be used to perform the machine learning process of the present disclosure, as discussed in more detail below.

Note that the graph network 200 is not limited to a transaction graph but may be other types of graphs or content display formats in various embodiments. For example, the graph network 200 may represent an electronic social network, where the nodes represent individual users of the electronic social network, and the edges represent the relationship between the individual users corresponding to the nodes connected by the edges. In that case, the features included in the nodes may include information such as the name, age, gender, employment status, etc. of the user, and the edges may include information that describe how the users are related (e.g., friend, work colleague, spouse, parent-child, employer-employee, etc.).

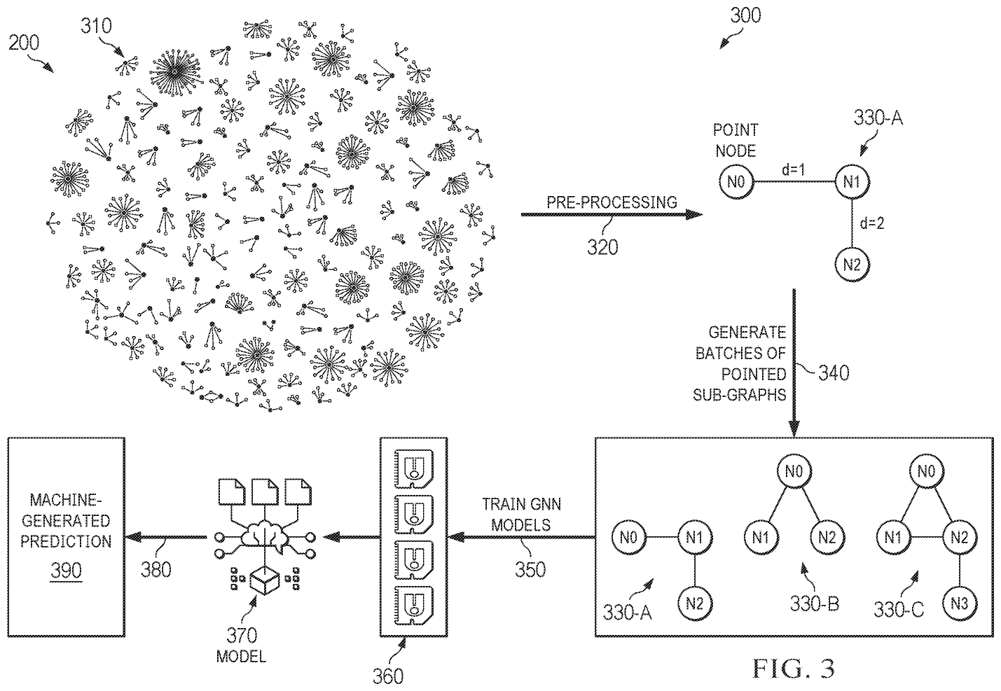

Referring now to FIG. 3, a simplified block diagram of a process flow 300 of the present disclosure is illustrated. The process flow 300 begins with a step 310, in which the graph network 200 of FIG. 2 (or a similar graph network) is accessed. In some embodiments, the graph network 200 is stored in an electronic storage, such as a Hadoop Distributed File System (HDFS), and the step 310 includes retrieving the graph network 200 from the electronic storage. Note that although Hadoop is used as an example herein, the concepts of the present disclosure are not limited to Hadoop systems. For example, the concepts herein may apply to other large-scale graphs, which may also be stored in Google Cloud Databases, Amazon Neptune, Neo4J, or any GPU/CPU supporting deep-learning modules. In some embodiments, the graph network 200 may be generated and/or maintained by the service provider that maintains/operates the payment provider server 170 of FIG. 1.

The process flow 300 continues with a step 320, in which pre-processing is performed to the graph network 200. As a part of the pre-processing, the graph network 200 is divided into a plurality of sub-graphs that are each substantially smaller than the graph network 200. For example, the sub-graphs may each include a point node and a plurality of other nodes that are one, two, or three hops away from the point node. The creation of the sub-graphs is to facilitate the subsequent data processing as a part of machine learning. For example, the amount of information contained within the graph network 200 may be quite large. In some instances, the graph network 200 may contain hundreds of thousands, if not millions, of nodes and their corresponding edges. It would be difficult for even the most powerful computer processors to process such a large amount of data as a part of the machine learning model training. As such, the graph network 200 is divided into a plurality of more manageable chunks (e.g., the sub-graphs) for simpler and more efficient processing. The sub-graphs may include several nodes (typically less than 10) that are interconnected together, including a point node that corresponds to an entity for which a decision or a prediction needs to be made.

For instance, a sub-graph 330-A is generated (as an example of one of the many sub-graphs) based on the graph network 200, where the sub-graph 330-A has a point node N0 and two other nodes N1 and N2. The point node N0 corresponds to an entity of interest. For example, in some embodiments, the entity of interest may be an entity that is suspected of having engaged in, or likely to engage in, a predefined type of activity, such as fraud. In some other embodiments, the entity of interest may be an entity for which a metric needs to be determined or calculated. For example, the entity may be a merchant, and the metric may be a business metric, such as a total payment volume, a total revenue, a total number of items sold, or a total number of transactions, over a specified period of time (e.g., a week, a month, or a quarter). In yet other embodiments, the entity of interest may be an entity for which a decision needs to be made. For example, the decision may be a decision to approve or deny a credit line or a loan for the entity. It is understood that the entity of interest may have other specified characteristics and/or include certain types of entities for which a prediction is to be made, but they are not specifically discussed herein for reasons of simplicity.

The step 320 also adds distance information between the various nodes of each sub-graph. For example, in the sub-graph 330-A, the point node N0 is connected to the node N1, and the node N1 is connected to the node N2, but the node N2 is not directly connected to the point node N0. In other words, the nodes N0 and B1 are immediate neighbors, and the nodes N2 and N1 are immediate neighbors, but the nodes N2 and N0 are not immediate neighbors. Note that the distance herein is calculated from the perspective of the point node N0. Accordingly, it may be said that the node N1 is one hop away from the point node N0, and the distance between the point node N0 and the node N1 is 1 (e.g., d=1, where d represents distance). Meanwhile, the node N2 is two hops away from the point node N0, and the distance between the point node N0 and the node N2 is 2 (e.g., d=2).

The step 320 may also embed feature information in each of the nodes. For example, the feature information embedded in the nodes may include, but is not limited to: name, age, gender, residential address, email address, phone number, employment status, username, password, bank account number, user identifier, device identifier, etc. In some embodiments, the step 320 may also embed the information corresponding to the edges between the connected nodes, such as information pertaining to a transaction between the entities corresponding to the connected nodes, or information pertaining to a relationship or other interactions between the entities corresponding to the connected nodes.

The process flow 300 proceeds to a step 340, in which various batches of pointed sub-graphs are generated. As a simplified example, a batch of the sub-graphs generated may include the sub-graph 330-A discussed above, a sub-graph 330-B, and a sub-graph 330-C. In some embodiments, batches are created by fixing a parameter “k” for the batch size. Every iteration, “k” point nodes are sampled, and the subgraphs are built around them. For ease of denotation, each of the respective points nodes of the sub-graphs 330-A, 330-B, and 330-C is denoted in FIG. 3 as NO, and the rest of the nodes in these sub-graphs may be denoted as N1, N2, or N3, even though two identically-labeled nodes from two different sub-graphs may or may not actually represent the same underlying entity. As discussed above, the sub-graph 330-A includes the point node N0, which is connected directly to the node N1, which itself is connected directly to the node N2. In the sub-graph 330-B, the point node N0 is connected directly to the node N1, as well as directly to the node N2. In the sub-graph 330-C, the point node N0 is connected directly to the node N1, as well as directly to the node N2. Meanwhile, the node N1 is connected directly to the node N2 as well, and the node N2 is connected directly to the node N3.

According to various aspects of the present disclosure, each of the sub-graphs (e.g., sub-graphs 330-A, 330-B, and 330-C) is a pointed sub-graph, in the sense that the step 340 defines a directional flow for the information exchanges among the various nodes in each of the sub-graphs. For example, in some embodiments, the pointed sub-graphs are configured such that for every node in the pointed sub-graph, information is propagated only in a direction towards the point node. In some embodiments, the following algorithm is employed to define the directional flow of information in the pointed sub-graph:
Determine the distance between the point node and every other node in the sub-graph.
Pass information from node A to node B (e.g., representing any two nodes) of the sub-graph only when both of the criteria below are met:
   1. The nodes (e.g., nodes A and B) are immediate neighbors (e.g., they are directly connected to one another); and
   2. The distance from the node B to the point node is less than the distance between the node A and the point node.

Listed below is example pseudo code for implementing the above algorithm:
#the following pseudo-code describes the pointed GNN algorithm
#it is a novel way to do a forward pass in a Graph Neural Network Message Passing Framework

input=(k,point_node,graph,delta,W)
#where:
#k is an integer
#point_node is a specific node id
#graph is a triple (V, E, X); V are k hop neighbors of point_node, E are edges in this k-hop subgraph around point_node, and X are the node features.
#delta is percentage
#W is a trainable deep-learning network with input dimension equal to X features' dimension
#initiate a sampled graph instance

sampled_graph=(V_s=None,E_s=None,X_s=None)#(nodes,edges,features)
#initiate a dictionary of neighbor distances

neighbor_distances={ }
#sample graph and calculate distances to point_node
for i in range (k):
   sample the i-hop neighbors around “point_node” with probability “delta” append the sampled neighbors, edges and features from graph to sampled_graph
   for each neighbor append it and its distance to the root “node” (the distance is i) to neighbor_distances
#we get:
#1. a sampled k-hop graph around “point_node”=(V_s, E_s, X_s)
#2. list of distances between neighbors and the root node
#define message-passing (there are many such implementations)

def MP(feature_vector=tensor,L=set of tensors,operation=sum):
h=feature_vector
#apply learned network on set
h_neighbors=[W(1) for 1 in L]
s=operation (h_neighbors) #can use avg, min, max, etc. too . . .
return W(h)+W(s)
#do message-passing with pointed root node as the center
for i in range (k):
   for neighbor in sampled_graph [V_s]:
      set L=[n_1, . . . n_j] the (immediate, 1-hop) neighbors of neighbor from sampled_graph
      remove from L any element whose distance to “point_node” is less than neighbor's distance to “point_node”
      update X_s[neighbor]=MP (X_s[neighbor], {X_s[y] for y in L}, operation=sum)

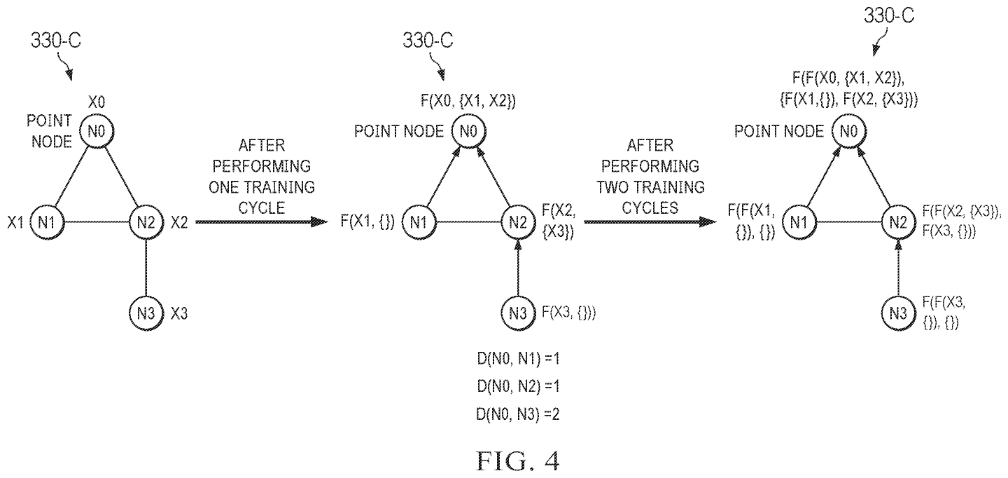

The above algorithm, when executed, helps to eliminate the returning information problem (e.g., redundant messages being exchanged between nodes), because the algorithm explicitly defines a directional flow for every node, so that information does not flow back and forth between nodes redundantly. In other words, the algorithm above reduces the smoothing issue that plagues conventional GNN schemes. The algorithm will be discussed in more detail later using a concrete sub-graph example with reference to FIG. 4.

Still referring to FIG. 3, the process flow 300 trains the GNN models in a step 350. The GNN model training of the step 350 is performed using the pointed sub-graphs with the defined directional flow for the passing of information between the nodes. In some embodiments, the GNN model training is performed by feeding the pointed sub-graphs into a Graphics Processing Unit (GPU) module 360, which may include a plurality of physical GPU cards. GPU cards are especially suited for performing machine-learning-related tasks, such as model training, because GPU cards are configured for parallel processing and can carry out multiple computations simultaneously.

In some embodiments, an entire batch of the pointed sub-graphs (e.g., the pointed sub-graphs 330-A, 330-B, and 330-C) may be fed into the GPU module 360 all at once to train the GNN models corresponding to the pointed sub-graphs 330-A, 330-B, and 330-C simultaneously. In embodiments where the batch of pointed sub-graphs generated by step 320 is still too large, a subset of the batch may be fed into the GPU module 360 at a time. The result of the step 350 is a plurality of trained GNN models that each correspond to a different one of the pointed sub-graphs. For example, a GNN model is trained for the sub-graph 330-A, another GNN model is trained for the sub-graph 330-B, and yet another GNN model is trained for the sub-graph 330-C.

As discussed above, the GNN model training herein is performed using pointed sub-graphs with defined directional flows for information exchanges. A detailed illustration of such a directional flow of information is shown in FIG. 4 using the sub-graph 330-C as an example. Referring to FIG. 4, the sub-graph 330-C includes the nodes N0, N1, N2, and N3, where N0 is the point node. The nodes N0, N1, N2, and N3 initially contain information represented by X0, X1, X2, and X3, respectively. In some embodiments, the information X0, X1, X2, and X3 may include the feature information embedded into the nodes N0, N1, N2, and N3 by the preprocessing step 320 of FIG. 3, such as name, age, gender, residential address, email address, phone number, employment status, username, password, bank account number, user identifier, device identifier, etc.

Before any GNN model training cycle is executed, the distances between the various nodes and the point node N0 have already been determined from the previous step 320 discussed above with reference to FIG. 3. In this example, the distance between the point node N0 and the node N1 is 1, the distance between the point node N0 and the node N2 is 1, and the distance between the point node N0 and the node N3 is 2. The above distances may also be represented mathematically by the following:

D(N0,N1)=1

D(N0,N2)=1

D(N0,N3)=2

The above distances are used to determine whether information should be exchanged between adjacent nodes as a part of the GNN model training. Note that the distance between the node N1 and the node N2 is irrelevant in this example, since the algorithm for the GNN model training focuses on the distance(s) measured with respect to the point node N0.

The execution of the algorithm is now discussed using the nodes N0 and N1 as an example. First, the nodes N0 and N1 are immediate neighbors, which meets criterion 1 of the algorithm discussed above. Assuming that the node N0 is the node A of the algorithm, and that the node N1 is the node B of the algorithm, the distance between the node B (e.g., node N1) and the point node N0 is 1, which is no less than the distance of 0 between the node A (e.g., node N0) and the point node N0. As such, criterion 2 of the algorithm is not satisfied, and therefore information does not flow from node A (N0 in this case) to node B (N1 in this case). This is represented by the fact that after 1 training cycle is performed, the information contained in the node N1 is now F(X1, { }). The empty brackets { } indicate that no other information is passed to the node N1. Thus, the only information contained in the node N1 is its own information, which is X1. Note that the function F( ) may be a variety of functions, such as a permutation-invariant function, an average, a sum, a maximum, a minimum, etc.

On the other hand, assuming that the node N1 is the node A of the algorithm and that the node N0 is the node B of the algorithm, the distance between the node B (e.g., node N0) and the point node N0 is still 0, which is less than the distance of 1 between the node A (e.g., node N1) and the point node N0. As such, criterion 2 of the algorithm is satisfied, and therefore information does flow from node A (N1 in this case) to node B (N0 in this case). This is represented by the fact that after one training cycle is performed, the information contained in the node N0 is now F(X0, {X1, X2}). In other words, the node N0 now contains not just its own information (e.g., X0), but also information corresponding to the node N1 (e.g., X1). Since the information flows from the node N1 to the node N0, but not from the node N0 to the node N1, it may be said that the flow of information is uni-directional as a part of the GNN model training herein. Such a uni-directionality of the flow of information is visually represented by an arrow pointing from the node N1 to the node N0.

The analysis between the node N0 and the node N2 is substantially similar to the analysis discussed above with reference to the node N0 and the node N1. As such, the above analysis is not repeated herein for reasons of simplicity. However, unlike the node N1, the node N2 is also connected to the node N3. The analysis of the information flow between the nodes N2 and N3 is as follows: the node N2 and the node N3 are immediate neighbors, which meets criterion 1 of the algorithm discussed above. Assuming that the node N2 is the node A of the algorithm and that the node N3 is the node B of the algorithm, the distance between the node B (e.g., node N3) and the point node N0 is 2, which is no less than the distance of 1 between the node A (e.g., node N2) and the point node N0. As such, criterion 2 of the algorithm is not satisfied, and therefore information does not flow from node A (N2 in this case) to node B (N3 in this case). This is represented by the fact that after one training cycle is performed, the information contained in the node N3 is now F(X3, { }). Again, the empty brackets { } indicates that no other information is passed to the node N3. Thus, the only information contained in the node N3 is its own information, which is X3.

On the other hand, assuming that the node N3 is the node A of the algorithm and that the node N2 is the node B of the algorithm, the distance between the node B (e.g., node N2) and the point node N0 is 1, which is less than the distance of 2 between the node A (e.g., node N3) and the point node N0. As such, criterion 2 of the algorithm is satisfied, and therefore information does flow from node A (N3 in this case) to node B (N2 in this case). This is represented by the fact that after one training cycle is performed, the information contained in the node N2 is now F(X2, {X3}). In other words, the node N2 now contains not just its own information (X2), but also information corresponding to the node N3. The fact that information flows from the node N3 to the node N2, but not from the node N2 to the node N3, further illustrates the uni-directionality of the information flow as a part of the GNN model training herein. Such a uni-directionality of the flow of information is visually represented by an arrow pointing from the node N3 to the node N2.

The algorithm discussed above may also be applied to the node N1 and the node N2. Since the node N1 and the node N2 are immediate neighbors, criterion 1 of the algorithm is met. Assuming that the node N1 is the node A of the algorithm, and that the node N2 is the node B of the algorithm, the distance between the node B (e.g., node N2) and the point node N0 is 1, which is no less than the distance of 1 between the node A (e.g., node N1) and the point node N0. As such, criterion 2 of the algorithm is not satisfied, and therefore information does not flow from node A (X1 in this case) to node B (X2 in this case). Likewise, assuming that the node N2 is the node A of the algorithm, and that the node N1 is the node B of the algorithm, the distance between the node B (e.g., node N1) and the point node N0 is 1, which is no less than the distance of 1 between the node A (e.g., node N2) and the point node N0. As such, criterion 2 of the algorithm is not satisfied, and therefore information does not flow from node A (X2 in this case) to node B (X1 in this case). The lack of information flow between the nodes N1 and N2 is visually represented by the fact that the connection between the nodes N1 and N2 has no pointed arrows.

It is understood that more than one GNN model training cycle can be executed as a part of the GNN model training. The algorithm used to update the information is still the same, although the information contained in the nodes is updated (and therefore may be different). For example, the information contained in the nodes N0, N1, N2, and N3 after the completion of the first training cycle is now F(X0, {X1, X2}), F(X1, { }), F(X2, {X3}), and F(X3, { }), respectively, as opposed to X0, X1, X2, and X3 before the first training cycle is performed. As such, after the completion of the second training cycle, the information contained in the point node N0 is now updated to F(F(X0, {X1, X2}), F(X1, { }), F(X2, {X3})), the information contained in the point node N1 is now updated to F(F(X1, { }), { }), the information contained in the point node N2 is now updated to F(F(X2, {X3}), F(X3, { })), and the information contained in the point node N3 is now updated to F(F(X3, { }), { }). Regardless of the exact information contained in any of the nodes, it is understood that the direction of the information flow is toward the point node.

The directionality of the information flow herein helps to reduce the passing of redundant messages among the nodes. In more detail, as a conventional GNN is trained, each node gets information from its adjacent nodes. For example, the node N0 may receive information from both the node N1 and the node N2, the node N1 may receive information from both the node N0 and the node N2, the node N2 may receive information from the node NO, the node N1, and the node N3, and the node N3 may receive information from the node N2. However, such an indiscriminate bi-directional information exchange may introduce redundancy. For example, as the node N0 is updated, it receives the information from the node N1 and the node N2. However, the node N2 also contains the information from the node N1 (since the node N2 has previously received the information from the node N1). The information corresponding to the node N1 received by the node N0 from the node N1 is duplicative of the information corresponding to the node N1 that is directly received by the node N0, and therefore the passing of the information corresponding to the node N1 from the node N2 to the node N0 is redundant and unnecessary. In addition to wasting valuable computer resources (e.g., GPU processing power, electronic memory storage, network communication bandwidth, etc.), such a redundancy also leads to a smoothing effect for the nodes. That is, as more GNN model training cycles are performed, the nodes begin to all look like one another, since each node will eventually contain more information about the rest of the nodes in the graph. The smoothing effect translates into less accurate predictions made by the resulting GNN model, which may also require additional computer resources to address and/or remedy.

In contrast, the GNN models herein are trained according to a defined directional flow for the information in the sub-graphs. For example, the algorithm discussed above ensures that, as the nodes are updated in each GNN training cycle, the information will flow unidirectionally toward the point node N0. Such a unidirectional flow prevents (or at least substantially reduces) the generation and passing of redundant electronic information among the nodes. Accordingly, the GNN model training of the present disclosure can save computer resources (e.g., GPU processing power, electronic memory storage, network communication bandwidth, etc.). In addition, the smoothing effect plaguing conventional GNN models is also reduced, even if a greater number of training cycles are performed. As a result, the trained GNN models herein can make better (e.g., faster and/or more accurate) predictions. For at least these reasons, the GNN model of the present disclosure amounts to an improvement in computer technology, as well as a practical application of the idea of improving accuracy and performance in machine learning.

Referring back to FIG. 3, the GNN model training performed by the GPU module 360 generates a plurality of trained GNN models 370. For example, each of the trained GNN models 370 may correspond to one of the sub-graphs (e.g., sub-graph 330-A, sub-graph 330-B, or sub-graph 330-C). The process flow 300 may then continue in a step 380 to make a prediction using one of the trained GNN models 370. For example, a request may be received to make a prediction about an entity corresponding to one of the point nodes N0. The prediction may be with respect to the point node and also with respect to a specified activity (e.g., fraud), a business metric (e.g., total payment volume, total number of items sold, total number of transactions, etc.), or a decision to grant or deny a credit application or a loan. As an example, a user A may be suspected of engaging in fraud. Therefore, the trained GNN model where the point node corresponds to the user A may be accessed to make an accurate machine-generated prediction from which an end user, system, and entity can use to determine a subsequent action, such as denying a transaction where the user A is predicted as engaging in fraud according to step 380. The result of the step 380 is the machine-generated prediction 390 as an output of one of the trained GNN model 370. As discussed above, the reduction of the smoothing effect according to the present disclosure can improve the accuracy of the machine-generated prediction 390 and/or the speed at which the machine-generated prediction is obtained.

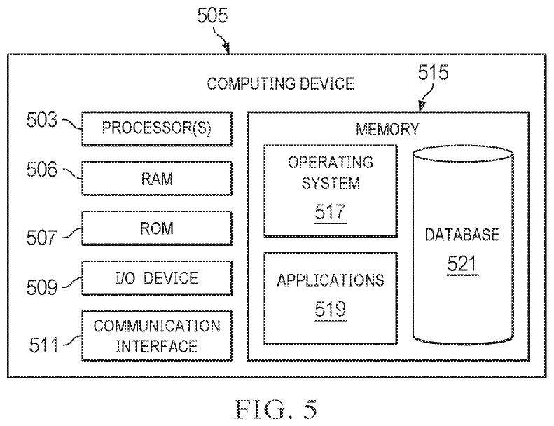

Turning now to FIG. 5, a computing device 505 that may be used with one or more of the computational systems is described. The computing device 505 may be used to implement various computing devices discussed above with reference to FIGS. 1-4. For example, the computing device 505 may be used to implement the directional GNN module 198 (or portions thereof) of FIG. 1, and/or other components (e.g., the transaction processing application 190) of the payment provider server 170. Furthermore, the computing device 505 may be used to implement the user device 105, the merchant server 140, the acquirer host 165, the issuer host 168, the directional GNN module 198, the GPU module 360, or portions thereof, in various embodiments. The computing device 505 may include one or more processors 503 for controlling overall operation of the computing device 505 and its associated components, including RAM 506, ROM 507, input/output device 509, communication interface 511, and/or memory 515. A data bus may interconnect processor(s) 503, RAM 506, ROM 507, memory 515, I/O device 509, and/or communication interface 511. In some embodiments, computing device 505 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 509 may include a microphone, keypad, touch screen, and/or stylus motion, gesture, through which a user of the computing device 505 may provide input, and may also include one or more speakers for providing audio output and a video display device for providing textual, audiovisual, and/or graphical output. Software may be stored within memory 515 to provide instructions to processor(s) 503 allowing computing device 505 to perform various actions. For example, memory 515 may store software used by the computing device 505, such as an operating system 517, application programs 519, and/or an associated internal database 521. The various hardware memory units in memory 515 may include volatile and nonvolatile, removable and non-removable media implemented in any method or technology for storage of information such as computer-readable instructions, data structures, program modules, or other data. Memory 515 may include one or more physical persistent memory devices and/or one or more non-persistent memory devices. Memory 515 may include, but is not limited to, random access memory (RAM) 506, read only memory (ROM) 507, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor(s) 503.

Communication interface 511 may include one or more transceivers, digital signal processors, and/or additional circuitry and software for communicating via any network, wired or wireless, using any protocol as described herein.

Processor(s) 503 may include a single central processing unit (CPU) in some embodiments, which may be a single-core or multi-core processor, or it may include multiple CPUs in other embodiments. In some embodiments, the processor(s) 503 may include one or more GPUs, in addition to, or in lieu of, the CPUs. The processor(s) 503 and associated components may allow the computing device 505 to execute a series of computer-readable instructions to perform some or all of the processes described herein. Although not shown in FIG. 5, various elements within memory 515 or other components in computing device 505, may include one or more caches, for example, CPU/GPU caches used by the processor 503, page caches used by the operating system 517, disk caches of a hard drive, and/or database caches used to cache content from database 521. For embodiments including a CPU/GPU cache, the CPU/GPU cache may be used by one or more processors 503 to reduce memory latency and access time. Processor(s) 503 may retrieve data from or write data to the CPU/GPU cache rather than reading/writing to memory 515, which may improve the speed of these operations. In some examples, a database cache may be created in which certain data from a database 521 is cached in a separate smaller database in a memory separate from the database, such as in RAM 506 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 505 are described separately, functionality of the various components may be combined and/or performed by a single component and/or multiple computing devices in communication without departing from the invention.

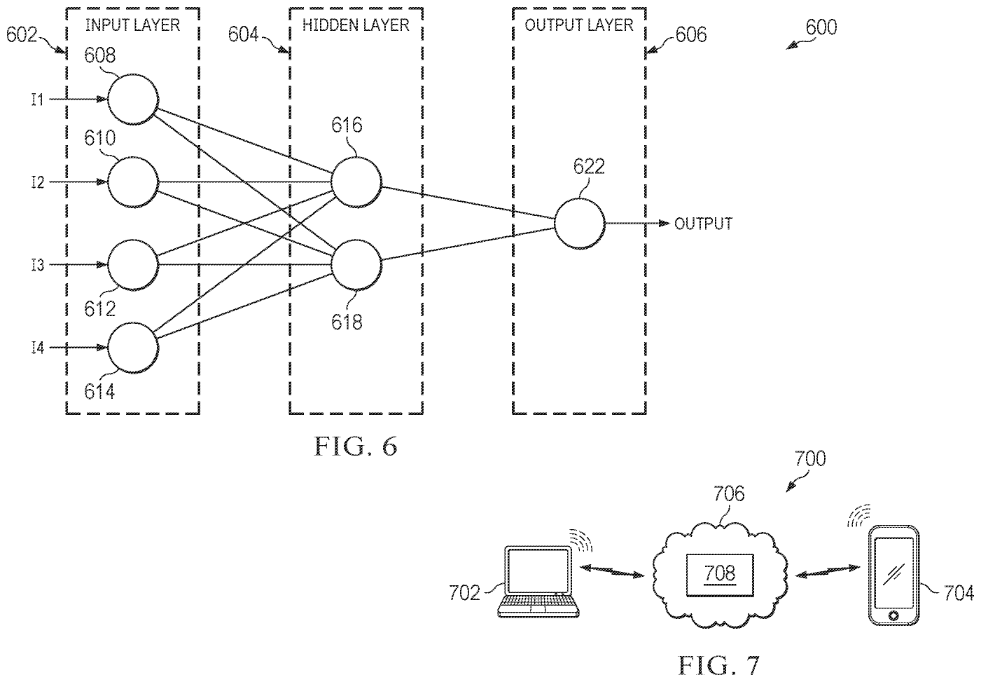

As discussed above, machine learning may be used to construct and/or implement the GNN models discussed above, or portions thereof. In some embodiments, the machine learning may be performed at least in part via an artificial neural network, which may be used to implement a machine learning module that can perform various machine learning processes. In that regard, FIG. 6 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the directional GNN module 198, and the directional GNN module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct data feature.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., occurrence of fraud, or a loan becoming bad due to missed payments or a loan default).

The artificial neural network 600 may be trained by using training data. For example, the training data herein may be the previous occurrences of fraud, defaults, late payments, or bad loans and their corresponding user data. By providing training data to the artificial neural network 600, the nodes 616-618 in the hidden layer 604 may be trained (adjusted) such that an optimal output is produced in the output layer 606 based on the training data. By continuously providing different sets of training data, and penalizing the artificial neural network 600 when the output of the artificial neural network 600 is incorrect (e.g., when the determined (predicted) likelihood of fraud or a bad loan is inconsistent with whether fraud occurred or the loan actually became bad, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the directional GNN module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the various processes discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

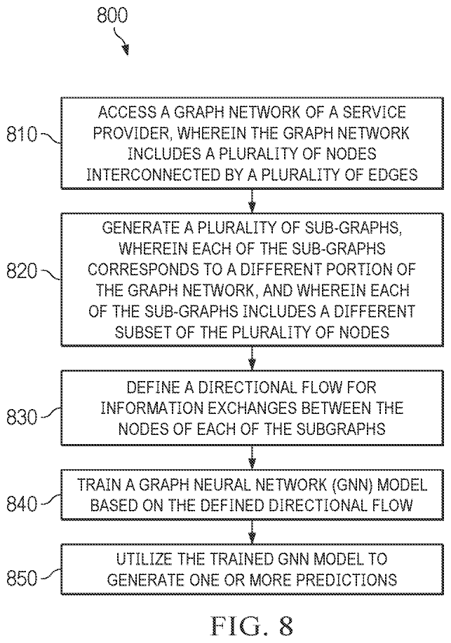

FIG. 8 is a flowchart illustrating a method 800 for a machine learning process according to various aspects of the present disclosure. The various steps of the method 800, which are described in greater detail above, may be performed by one or more electronic processors, for example by the processors of a computer of an entity that may include (but are not limited to): a payment provider, a business analyst, or a merchant. The networked system described with respect to FIG. 1 is an example of a system that can perform the method 800. For example, the steps 810-850 of the method 800 may be performed by the payment provider server 170 of FIG. 1. In some embodiments, at least some of the steps of the method 800 may be performed by the directional GNN module 198 discussed above. For example, steps 810-840 of the method 800 may be performed by the directional GNN module 198 of FIG. 1, while step 850 of the method 800 may also be performed by the directional GNN module 198 in some embodiments, or the step 850 may be performed by another component (e.g., the transaction processing application 190) of or associated with the payment provider server 170 of FIG. 1 in other embodiments.

The method 800 includes a step 810 to access a graph network of a service provider. The graph network includes a plurality of nodes interconnected by a plurality of edges. In some embodiments, the step 810 comprises retrieving the graph network from a Hadoop Distributed File System (HDFS). In some embodiments, the graph network is the graph network 200 discussed above with reference to FIG. 2.

The method 800 includes a step 820 to generate a plurality of sub-graphs. Each of the sub-graphs corresponds to a different portion of the graph network. Each of the sub-graphs includes a different subset of the plurality of nodes. In some embodiments, the sub-graphs may include the sub-graphs 330-A, 330-B, or 330-C discussed above with reference to FIG. 3, or the sub-graph 330-C discussed above with reference to FIG. 4.

The method 800 includes a step 830 to define a directional flow for information exchanges between the nodes of each of the sub-graphs. In some embodiments, the directional flow is discussed with reference to FIG. 4.

The method 800 includes a step 840 to train a graph neural network (GNN) model based on the defined directional flow. In some embodiments, the GNN model is trained using the GPU module 360 of FIG. 3.

The method 800 includes a step 850 to utilize the trained GNN model to generate one or more predictions. In some embodiments, the trained GNN model comprises the GNN model 370 of FIG. 3, and the one or more predictions comprise the machine-generated prediction 390 of FIG. 3. In some embodiments, a method may first access the trained GNN model, such as through steps 810 to 840, and then utilize the accessed trained GNN model at step 850 to generate one or more predictions for a requested transaction or desired output prediction.

In some embodiments, the plurality of sub-graphs is generated such that each of the sub-graphs includes a point node, respectively. The directional flow is defined based on distances between the point node and a rest of the nodes in each of the sub-graphs. In some embodiments, the directional flow is defined such that the information exchanges between a subset of the nodes are uni-directional toward the point node. In some embodiments, the directional flow is defined at least in part based on a comparison of a first distance between the point node and a first node of the plurality of nodes and a second distance between the point node and a second node of the plurality of nodes. In some embodiments, the one or more predictions of the step 850 are generated with respect to the point node.

In some embodiments, the directional flow is defined for the information exchanges between different pairs of directly-connected nodes in each of the sub-graphs.

In some embodiments, each node of the plurality of nodes is associated with a respective user account with the service provider, and each edge of the plurality of edges is associated with an interaction between the respective user accounts associated with the nodes that are interconnected by the edge.

In some embodiments, the one or more predictions comprise a prediction with respect to a predefined activity, a predefined metric, or a predefined decision. In some embodiments, the predefined activity comprises an occurrence of fraud, the predefined metric comprises a total payment volume, a total revenue, a total number of items sold, or a total number of transactions, over a specified period of time, or the predefined decision comprises a decision to approve or deny a credit application or a loan.

It is understood that additional method steps may be performed before, during, or after the steps 810-850 discussed above. For example, the method 800 may include a step of performing one or more preprocesses to the graph network before the generating of the plurality of sub-graphs. In some embodiments, the preprocesses comprise calculating the distances between the point node and the rest of the nodes in each of the sub-graphs, or embedding one or more data features in each of the nodes in each of the sub-graphs. For reasons of simplicity, these additional steps are not discussed in detail herein.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. The method includes: accessing a graph network of a service provider, wherein the graph network includes a plurality of nodes interconnected by a plurality of edges; generating a plurality of sub-graphs, wherein each of the sub-graphs corresponds to a different portion of the graph network, and wherein each of the sub-graphs includes a different subset of the plurality of nodes; defining a directional flow for information exchanges between the nodes of each of the sub-graphs; training a graph neural network (GNN) model based on the defined directional flow; and utilizing the trained GNN model to generate one or more predictions.

Another aspect of the present disclosure involves a system that includes a non-transitory memory and one or more hardware processors coupled to the non-transitory memory and configured to read instructions from the non-transitory memory to cause the system to perform operations comprising: accessing a graph that includes a plurality of nodes that are interconnected together, wherein each of the nodes represents a different entity; dividing the graph into a plurality of sub-graphs, wherein each of the sub-graphs includes a different subset of the plurality of nodes, and wherein each of the sub-graphs includes a point node, respectively; determining, for each of the sub-graphs, distances between the point node and a rest of the nodes in the sub-graph; training a graph neural network (GNN) model based on a directional flow of information among the nodes in each of the sub-graphs, wherein the directional flow of information is defined at least in part based on the determined distances between the point node and the rest of the nodes in the sub-graph; and generating one or more predictions via the trained GNN model.

Yet another aspect of the present disclosure involves a non-transitory machine-readable medium having stored thereon machine-readable instructions executable to cause a machine to perform operations comprising: accessing a graph neural network (GNN) model trained based on a directional flow defined for information exchanges between nodes of each of a plurality of sub-graphs, wherein each of the nodes are interconnected by a plurality of edges in a graph network of a service provider, wherein each of the sub-graphs corresponds to a different portion of the graph network, and wherein each of the sub-graphs includes a different subset of the plurality of nodes; and generating, using the trained GNN model, one or more outputs representing one or more predictions associated with a transaction or an offer.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, while protected attributes are described, non-protected attributes that may unfairly bias a user and have no bearing on a decision to offer a benefit or protect are also part of present disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing a graph network of a service provider, wherein the graph network includes a plurality of nodes interconnected by a plurality of edges;
generating a plurality of sub-graphs, wherein each of the sub-graphs corresponds to a different portion of the graph network, and wherein each of the sub-graphs includes a different subset of the plurality of nodes;
defining a directional flow for information exchanges between the nodes of each of the sub-graphs;
training a graph neural network (GNN) model based on the defined directional flow; and
generating one or more predictions utilizing the trained GNN model.

2. The method of claim 1, wherein:
the plurality of sub-graphs is generated such that each of the sub-graphs includes a point node, respectively; and
the defining the directional flow is based on distances between the point node and a rest of the nodes in each of the sub-graphs.

3. The method of claim 2, further comprising: performing one or more preprocesses to the graph network before the generating of the plurality of sub-graphs, wherein performing the preprocesses comprises:
calculating the distances between the point node and the rest of the nodes in each of the sub-graphs; or
embedding one or more data features in each of the nodes in each of the sub-graphs.

4. The method of claim 2, wherein the directional flow is defined such that the information exchanges between a subset of the nodes are uni-directional toward the point node.

5. The method of claim 2, wherein the directional flow is defined at least in part based on a comparison of a first distance between the point node and a first node of the plurality of nodes and a second distance between the point node and a second node of the plurality of nodes.

6. The method of claim 2, wherein the one or more predictions are generated with respect to the point node.

7. The method of claim 1, wherein the directional flow is defined for the information exchanges between different pairs of directly-connected nodes in each of the sub-graphs.

8. The method of claim 1, wherein:
each node of the plurality of nodes is associated with a respective user account with the service provider; and
each edge of the plurality of edges is associated with an interaction between the respective user accounts associated with the nodes that are interconnected by the edge.

9. The method of claim 1, wherein the one or more predictions comprise a prediction with respect to a predefined activity, a predefined metric, or a predefined decision.

10. The method of claim 9, wherein:
the predefined activity comprises an occurrence of fraud;
the predefined metric comprises a total payment volume, a total revenue, a total number of items sold, or a total number of transactions over a specified period of time; or
the predefined decision comprises a decision to approve or deny a credit application, a loan, or a transaction.

11. The method of claim 1, wherein the accessing the graph network comprises retrieving the graph network from a Hadoop Distributed File System (HDFS).

12. A system, comprising:
one or more processors; and
a non-transitory computer-readable medium having stored thereon instructions that are executable by the one or more processors that cause the system to perform operations comprising:
accessing a graph that includes a plurality of nodes that are interconnected, wherein each of the nodes represents a different entity;
dividing the graph into a plurality of sub-graphs, wherein each of the sub-graphs includes a different subset of the plurality of nodes, and wherein each of the sub-graphs includes a point node, respectively;
determining, for each of the sub-graphs, distances between the point node and a rest of the nodes in the sub-graph;
training a graph neural network (GNN) model based on a directional flow of information among the nodes in each of the sub-graphs, wherein the directional flow of information is defined at least in part based on the determined distances between the point node and the rest of the nodes in the sub-graph; and
generating one or more predictions via the trained GNN model.

13. The system of claim 12, wherein the directional flow of information is defined such that the information flows from a first node of a sub-graph to a second node of the sub-graph only when:
the first node and the second node are directly connected; and
a distance from the second node to the point node is less than a distance between the first node and the point node.

14. The system of claim 12, wherein the training is performed for a plurality of cycles, and wherein in each cycle of the plurality of cycles, information among the nodes flows uni-directionally toward the point node.

15. The system of claim 12, wherein the one or more predictions are generated with respect to the point node.

16. The system of claim 15, wherein:
the graph comprises a transaction graph of a service provider;
the plurality of nodes represent a plurality of users of the service provider; and
the point node represents a user that is associated with a fraudulent activity, a user for whom a business metric needs to be determined, a user involved in a transaction, or a user for whom a credit application or a loan decision needs to be made.

17. The system of claim 12, wherein the plurality of nodes are interconnected by a plurality of edges that represent interactions among the plurality of nodes, and wherein information associated with the plurality of nodes and the plurality of edges are stored in a Hadoop Distributed File System (HDFS).

18. A non-transitory machine-readable medium having stored thereon machine-readable instructions executable to cause a machine to perform operations comprising:
accessing a graph neural network (GNN) model trained based on a directional flow defined for information exchanges between nodes of each of a plurality of sub-graphs, wherein each of the nodes are interconnected by a plurality of edges in a graph network of a service provider, wherein each of the sub-graphs corresponds to a different portion of the graph network, and wherein each of the sub-graphs includes a different subset of the plurality of nodes; and
generating, using the trained GNN model, one or more outputs representing one or more predictions associated with a transaction or an offer.

19. The non-transitory machine-readable medium of claim 18, wherein each of the sub-graphs includes a point node, respectively, wherein the prediction is generated with respect to an entity corresponding to the point node.

20. The non-transitory machine-readable medium of claim 19, wherein the operations further comprise defining an information flow direction within each sub-graph at least in part based on distances between the point node and a rest of the nodes in the sub-graph.
